(19) United States
(12) Patent Application Publication
(10) Pub. No.: US 2004/0260661 A1
(43) Pub. Date: Dec. 23, 2004

(54) Security mailing system

(76) Inventor: Peter C. Lytle, Wayzata, MN (US)

Correspondence Address: PATENT ADMINSTRATOR, KATTEN MUCHIN ZAVIS ROSENMAN, 525 WEST MONROE STREET, SUITE 1600, CHICAGO, IL, 60661-3693, US

(21) Appl. No.: 10/830,628

(22) Filed: Apr. 23, 2004

(30) Foreign Application Priority Data
Oct. 24, 2002 (WO) PCT/US02/34111

(51) Int. Cl. G06F 17/00

(52) U.S. Cl. 705/402

(57) ABSTRACT

A mailing system providing enhanced security for mailings processed and accepted by the mailing system. The mailing system uses sensed biometric data from the customer and/or sensed mailing type data from a secured mailing for creation of a database correlating trackable mailings to biometric data of the customer posting the mailing, placing biometric data of the customer posting a mailing onto the mailing and/or identifying suspicious mailings deserving special attention during transportation and delivery.

This application claims the benefit of U.S. Provisional Application No. 60/345,861, filed Oct. 24, 2001.

### FIELD OF INVENTION

The invention relates to the acceptance, shipment and delivery of parcels, packages and letters.

### BACKGROUND

Mailings are currently accepted for shipment and delivery without an identification of the customer. Identification of the customer is typically voluntary, and even when required is not verified.

The anonymous nature of a mailing attracts those prone to misbehavior to utilize mailings to achieve improper ends ranging from fraudulent solicitation of funds to the delivery of a biological material known to cause disease with the intent to infect the recipient.

Accordingly, a substantial need exists for allowing reliable correlation of a mailing to a customer.

### BRIEF DESCRIPTION OF THE DRAWINGS

FIG. 1 is a front perspective view of one embodiment of the invention.

FIG. 2 is a front view of the invention shown in FIG. 1.

FIG. 3 is an enlarged perspective view of one embodiment of a secured retention system of one embodiment of the invention.

FIG. 4 is a schematic view of one embodiment of a control system for the invention.

### SUMMARY OF THE INVENTION

Biometric Data Correlated to a Mailing

A first structural aspect of the invention is a security mailing system which comprises (i) a means for receiving and securely retaining a mailing, (ii) a means for sensing and electronically recording biometric data from a customer, (iii) a means for placing identification code data upon a mailing received and securely retained by the receiving and retention means, (iv) a means for correlating the placed identification code data with contemporaneously sensed biometric data, and (v) a means for retrievably electronically storing the correlated identification code data and biometric data.

A first procedural aspect of the invention is a method of mailing, comprising (i) receiving and securely retaining a mailing deposited into a security mailing system by a customer, (ii) sensing and electronically recording biometric data from the customer, (iii) placing identification code data upon the retained mailing, (iv) correlating the placed identification code data with contemporaneously sensed biometric data, and (v) electronically storing the correlated identification code data and biometric data.

Biometric Data Placed onto a Mailing

A second structural aspect of the invention is a security mailing system which comprises (i) a means for sensing and electronically recording biometric data from a customer, and (ii) a means for automatically and securely placing at least a portion of sensed and recorded biometric data from a customer onto a mailing from the customer.

A second embodiment of the second structural aspect of the invention is a security mailing system which comprises (i) a means for receiving and securely retaining a mailing, (ii) a means for sensing and electronically recording biometric data from a customer, and (iii) a means for automatically placing at least a portion of sensed biometric data onto a mailing contemporaneously received and securely retained by the receiving and retention means.

A second procedural aspect of the invention is a method of mailing, comprising (i) receiving and securely retaining a mailing from a customer, (ii) sensing and electronically recording biometric data from the customer, and (iii) automatically and securely placing at least a portion of the sensed and recorded biometric data from the customer onto the mailing.

Biometric Data Screening of Mailings

(Identifying Suspicious Mailing w/ Notice)

A third structural aspect of the invention is a security mailing system which comprises (i) a means for receiving and securely retaining a mailing, (ii) a means for sensing biometric data about a customer contemporaneously with receipt and retention of a mailing within the receiving and retention means, (iii) means for accessing a database containing biometric data of persons prone to misconduct involving mailings, (iv) means for comparing sensed biometric data with biometric data in the biometric database, (v) means for automatically identifying a mailing retained within the receiving and retention means as a suspicious mailing when the sensed biometric data matches biometric data in the biometric database, and (vi) means for automatically providing notice of receipt of a suspicious mailing to authorities when a suspicious mailing is identified.

A third procedural aspect of the invention is a method of mailing, comprising (i) receiving and securely retaining a mailing deposited into a security mailing system by a customer, (ii) sensing biometric data about the customer, (iii) accessing a database containing biometric data of persons prone to misconduct involving mailings, (iv) comparing the sensed biometric data with the biometric data in the biometric database, (v) automatically identifying the mailing deposited into the security mailing system as a suspicious mailing when the sensed biometric data matches biometric data in the biometric database, and (vi) automatically providing authorities with notice of receipt of a suspicious mailing when a suspicious mailing is identified.

(Preventing Access)

A fourth structural aspect of the invention is a security mailing system normally inoperable for processing a mailing, which comprises (i) a means for receiving and securely retaining a mailing, (ii) a means for sensing biometric data about a customer, (iii) means for accessing a database containing biometric data of persons prone to misconduct involving mailings, (iv) means for comparing sensed biometric data with biometric data in the biometric database, and (v) means for temporarily rendering the security mailing system operable for processing a mailing when sensed biometric data does not match biometric data in the biometric database.

A fourth procedural aspect of the invention is a method of mailing, comprising (i) providing a mailing system normally inoperable for processing a mailing and having a means for receiving and securely retaining a mailing, (ii) sensing biometric data about a customer, (iii) accessing a database containing biometric data of persons prone to misconduct involving mailings, (iv) comparing the sensed biometric data with biometric data in the biometric database, and (v) temporarily rendering the mailing system operable for processing a mailing when the sensed biometric data does not match biometric data in the biometric database.

Mailing Characteristic Screening

A fifth structural aspect of the invention is a security mailing system which comprises (i) a means for receiving and securely retaining a mailing, (ii) a means for sensing and recording mailing type data about a mailing securely retained within the receiving and retention means, (iii) a means for accessing a database containing mailing type data for mailing types posing an increased threat for use in misconduct involving a mailing, (iv) a means for comparing sensed mailing type data with mailing type data in the mailing type database, (v) a means for automatically identifying a mailing retained within the receiving and retention means as a suspicious mailing when the sensed mailing type data matches a mailing type in the mailing type database, and (vi) a means for automatically providing notice of receipt of a suspicious mailing to authorities when a suspicious mailing is identified.

### DETAILED DESCRIPTION OF THE INVENTION INCLUDING A BEST MODE

Nomenclature

010 Security Mailing System

012 Platform

020 Magnetic Card Reader

030 Video Display Terminal

040 Keyboard

050 Printer (receipts)

060 Fingerprint Sensor

070 Camera (facial picture)

080 Camera (vicinity picture)

095 Warning Light

096 Speaker

100 Secured Retention System

102 Inner Door

104 Outer Door

106 Magnetic Lock

109 Processing Chamber

110 Scale

120 Dimensioning System

120x x-axis Dimension Sensor

120y y-axis Dimension Sensor

120z z-axis Dimension Sensor

130 Printer (mailing labels)

140 Storage Area

150 Access Door

200 Central Processing Unit

210 Power Supply

220 Communications Link

500 Mailing

Definitions

As utilized herein, including the claims, the term “authorities” includes persons responsible for overseeing the safety of others in connection with the acceptance, shipment and delivery of parcels, packages and letters. Authorities include specifically, but not exclusively, the owner of a mailing system, the owner or manager of a business in which a mailing system is located, delivery services such as the United States Postal Service and United Parcel Service, state agencies such as the local police and fire department, and federal agencies such as Homeland Security, the Federal Bureau of Investigation, and the Central Intelligence Agency.

As utilized herein, including the claims, the phrase “biometric data” means biological information effective for assisting in distinguishing a human from the general population. Biometric data includes specifically, but not exclusively, group data such as body height, body weight, eye color, hair color, foot size, blood type, gender, etc., and unique data such as facial photograph, fingerprint, DNA, facial recognition, voice recognition, eye recognition, etc.

As utilized herein, including the claims, the term “electronic camera” includes snap-shot cameras, camcorders, video cameras and other similar electronic equipment capable of recording an electronic image of a scene.

As utilized herein, including the claims, the term “contemporaneous” means occurring during the same time period so as to define a single continuous transaction.

As utilized herein, including the claims, the phrase “destination data” means address information sufficient to allow delivery of a mailing by a delivery service to the intended recipient.

As utilized herein, including the claims, the phrase “electronically tag” means to electronically classify electronic data wherein the electronic classification is useful for subsequent location of the tagged electronic data by searching the electronic classification. Electronic tagging allows identification of tagged electronic data (e.g., an identification code placed upon a mailing) as a member of a specified class (e.g., a suspicious mailing).

As utilized herein, including the claims, the phrase “mailing type data” means information about the physical attributes and characteristics of a mailing. Mailing type data includes specifically, but not exclusively, length, height, width, shape, volume, weight, density, transparency to x-rays, source of electromagnetic radiation, etc.

As utilized herein, including the claims, the phrase “misconduct involving mailings” means use of mailings to achieve physically harm or threaten physical harm to another. By way of nonlimiting example, misconduct involving mailings includes mailing of an explosive device set to detonate, mailing of a biological material known to cause disease without proper containment or labeling, mailing of a toxic chemical without proper containment or labeling, mailing of a radioactive substance without proper containment or labeling, mailing a threat to commit a felony against a person, etc.

As utilized herein, including the claims, the phrase “persons prone to misconduct involving mailings” includes persons having a personal history, persons associating with others who have a personal history, and/or persons affiliated with organizations with a history or propensity of utilizing mailings to harm others and/or damage property.

As utilized herein, including the claims, the term “securely” means protected against external influences such that persons may not influence, alter or otherwise interfere. By way of nonlimiting example, secured placement of biometric data onto a mailing may be achieved by preventing persons, including the customer of the mailing, from accessing the biometric data or the mailing during such placement.

As utilized herein, including the claims, the term “mailing” means any item consigned by one person to another for transportation and delivery by the other to a defined person or location. Mailings include specifically, but not exclusively, packages, parcels, letters, and documents.

As utilized herein, including the claims, the phrase “perceptible signal” means any and all means of communication capable of conveying notice or warning, including specifically, but not exclusively audible signals (e.g., blaring alarm), visual signals (e.g., flashing light), and multimedia signals (e.g., specific set of tones with blue light).

As utilized herein, including the claims, the phrase “local perceptible signal” means generation of a perceptible signal capable of being perceived by those at the location where the actions precipitating the signal occurred (e.g., person(s) in the same room, person(s) in the same building, person(s) within visual range of the actions precipitating the signal, person(s) within audible range of a 70 dB audible signal generated from the site of the actions precipitating the signal, etc.).

As utilized herein, including the claims, the phrase “target destination” means a mailing address identified as a likely destination for a terroristic mailing. By way of nonlimiting example, target destinations include the White House, the Pentagon, the residence of a United States Congressman, a stadium or arena, the corporate offices of a Fortune 100 company, the residence of a famous actress, etc.

As utilized herein, including the claims, the phrase “telecommunications contact information”means a telephone number, a facsimile number, a pager number, an e-mail address or other similar number or code through which immediate communication of information is possible.

Construction

The mailing system 10 provides enhanced security for mailings 500 processed and accepted by the mailing system 10. The mailing system 10 uses sensed biometric data from the customer and/or sensed mailing type data from a secured mailing 100 for (i) creation of a database correlating trackable mailings 500 to biometric data of the customer posting the mailing 100, (ii) placing biometric data of the customer posting a mailing 500 onto the mailing 500, and/or (iii) identifying suspicious mailings deserving special attention during transportation and delivery.

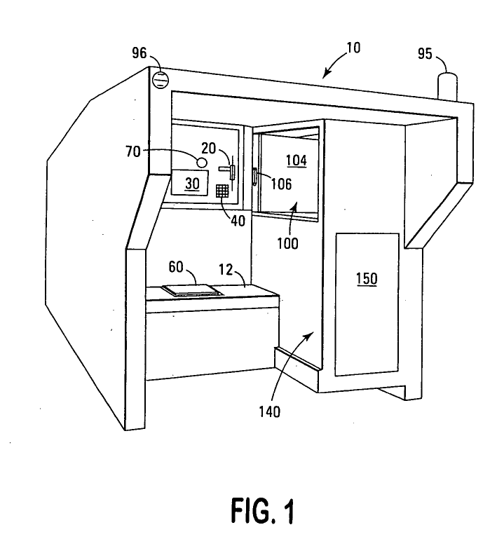

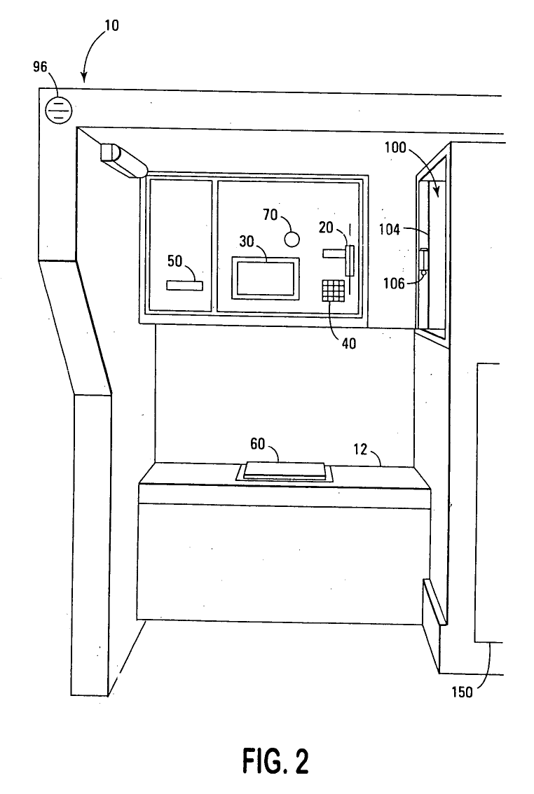

The security mailing system 10 may be constructed as an integrated or modular system and may be constructed as a free-standing or built-in system. For purposes of simplifying a detailed discussion of the invention, the balance of the discussion provided herein shall be provided in connection with an integrated, free-standing system 10 such as shown in FIGS. 1 and 2.

The embodiment of the security mailing system 10 shown in FIGS. 1 and 2 accepts and stores mailings 500 for subsequent pick-up by a commercial carrier and provides a customer (not shown) with access to sufficient tools and information to permit complete processing of a mailing 500. An outer housing (unnumbered) defines a storage area 140 for holding mailings 500 which have been processed and accepted for transport. The security mailing system 10 includes a customer interface area (unnumbered), which can be positioned beneath a hooded overhang (unnumbered) to provide privacy and protect a customer from the elements during use of the security mailing system 10. The customer interface area can include a horizontal platform 12 upon which a customer can place mailings 500 or other items used in processing a mailing 500 using the security mailing system 10.

The customer interface area can include a device for accepting payment such as a magnetic card reader 20, a visual display such as a video display terminal 30, a user interface such as a keyboard or key pad 40, a printer 50 for printing a receipt or other transactional record (not shown), and one or more biometric sensors such as a fingerprint sensor 60 and/or a camera 70 configured and arranged to capture an image of a customer's facial features.

Access to a secured retention system 100 is also provided from the customer interface area for securely accepting a mailing 500 from the customer and processing the mailing 500 for shipment to a destination provided by the customer. The secured retention system 100 is constructed so that once a mailing 500 is placed within the processing chamber 109, the mailing 500 is not accessible to the customer unless the customer voluntarily terminates the transaction. This prevents a customer from switching a mailing 500 accepted for shipment or otherwise manipulating processing of the mailing 500. A variety of systems are known for securely accepting and retaining an item. One embodiment shown in FIGS. 1-3 includes alternately locked inner 102 and outer 104 doors defining a secured processing chamber 109 between the doors 102 and 104. Outer door 104 is biased in the closed position and secured in a locked condition, such as by activation of a magnetic lock 106, once a mailing 500 is placed within the processing chamber 109 by a customer. The control system 200 deactivates the magnetic lock 106 and allows a customer to access the mailing 500 placed within the processing chamber 109 only upon termination of the transaction.

Upon completion of a transaction involving a mailing 500 retained within the secured processing chamber 109, a mechanism (not shown) automatically moves the processed mailing 500, from the secured processing chamber 109 to the storage area 140 by opening the inner door 102 and sliding the mailing 500 through the opening.

A lockable access door 150 is provided in the housing for allowing service personnel or representatives of an authorized delivery services to access processed mailings 500 stored in the storage area 140.

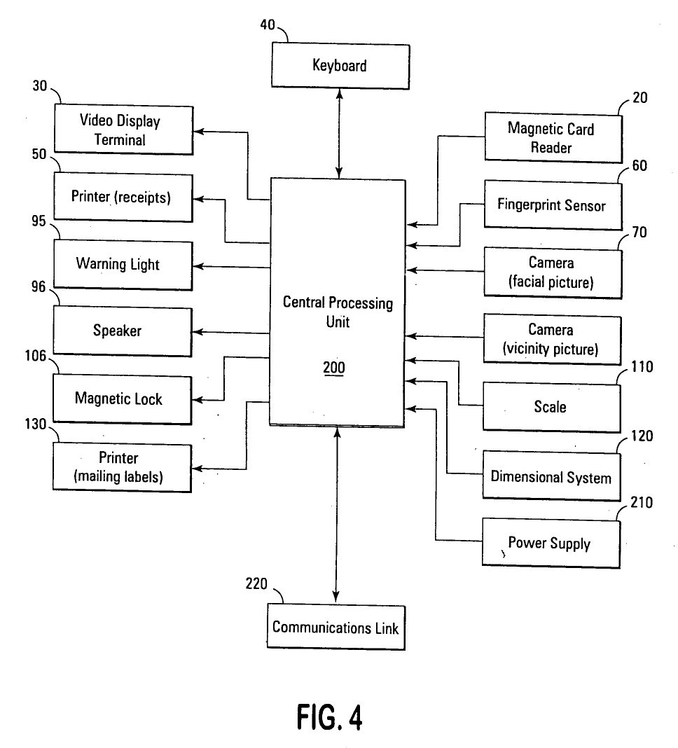

A control system 200 coordinates various sensors, motors, and input/output devices throughout the security mailing system 10. Control system 200 is schematically illustrated in FIG. 4 and includes a central processing unit (CPU) 200. Inputs to the CPU 200 can include (i) the magnetic card reader 20, fingerprint sensor 60, and facial camera 70 positioned in the customer interface area, (ii) scale 110 and dimensioning system 120 positioned within the processing chamber 109, and (iii) an externally positioned vicinity camera 80 and power supply 210. Outputs from the CPU 200 can include (i) the video display terminal 30, and receipt printer 50, positioned in the customer interface area, (ii) mailing label printer 130 and magnetic lock 106 positioned within the processing chamber 109, and (iii) externally positioned warning light 95 and speaker 96. Interfaces with the CPU 200 can include the keyboard 40 positioned within the processing chamber 109, and a communications link 220 for communicating with external databases and authorities.

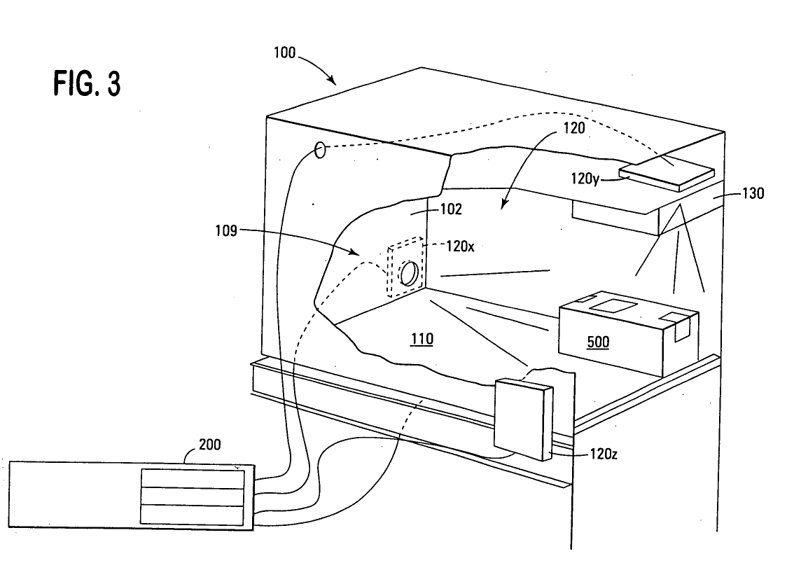

A dimensioning system 120 can be provided within the processing chamber 109 for measuring the dimensions of a mailing 500 retained within the processing chamber 109. The dimensioning system 120 depicted in FIG. 3 includes an x-axis dimensioning sensor 120×, a y-axis dimensioning sensor 120y and a z-axis dimensioning sensor 120z. A variety of suitable dimensioning sensors are known, including ultrasonic distance transducers, light curtain sensors, laser transducers, active scan sensors, etc. Alternatively, a holographic measuring system (not shown) may be used.

As shown in FIG. 3, a scale 110 can be provided within the processing chamber 109 for measuring the weight of a mailing 500 retained within the processing chamber 109.

Mailing label printer 130 is positioned within the processing chamber 109 for automatically placing information onto a mailing 500 without the assistance of a customer. The mailing label printer 130 may print directly onto a mailing 500 or may print upon an adhesive label (not shown) which is then automatically adhered to the mailing 500. In addition to mailing information, the mailing label printer 130 may also print other information to be placed upon a mailing 500 securely retained within the processing chamber 109 including biometric data and identification code data.

An area camera (not shown) can be employed for recording an image of the area surrounding the security mailing system 10 during a transaction for purposes of detecting and recording the presence of any persons (not shown) who may be influencing the transaction other than the customer.

Use

The security mailing system 10 is deployed to a desired location. Once the security mailing system 10 is positioned, the CPU 200 is programmed to interface with potential customers by providing the necessary programming input. Typically, the loaded information includes the appropriate zone and weight charges for all client delivery services as well as the delivery services available from the licensed commercial delivery service providers. The programmer also loads the corresponding fee files, which correspond to each client delivery service available at that location. Once all such information has been loaded into CPU 200, security mailing system 10 is ready to interact with potential customers.

To begin a shipping transaction, a customer approaches the security mailing system 10 and enters the customer interface area. The customer then touches the appropriate poirtion of the video display terminal 30 or keyboard 40 to initiate operation of the security mailing system 10.

The system software can then guide the customer though al shipping transaction, such as discussed and disclosed in detail in U.S. Pat. No. 5,233,532 issued to Ramsden, U.S. Pat. No. 5,340,948 issued to Ramsden, U.S. Pat. No. 5,369,221 issued to Ramsden, U.S. Pat. No. 5,481,464 issued to Ramsden, U.S. Pat. No. 5,656,799 issued to Ramsden, and U.S. Pat. No. 5,831,220 issued to Ramsden et al. The disclosure of these patents pertaining to a shipping transaction is hereby expressly incorporated.

The customary steps and procedures used to effect a shipping transaction, such as disclosed in the Ramsden patents, are adjusted and augmented by the invention in order to enhance the security with which a mailing 500 is accepted by the security mailing system 10.

A first aspect of the invention effective for enhancing the security of mailings 500 processed by the security mailing system 10 (i) senses and records biometric data from a customer, such as a facial photograph or a fingerprint, (ii) places identification code data, such as a unique UPC tracking number, upon the mailing 500 retained within processing chamber 109, (iii) correlates the identification code data placed upon the mailing 500 with the biometric data sensed from the customer, and (iv) retrievably stores the correlated identification code data and biometric data in electronic memory. The correlated data is preferably stored at a single, central location for access by authorized personnel. Such correlated data facilitates subsequent location and identification of a person involved with posting of a mailing 500 in the event such mailing 500 is involved in misconduct.

Optionally, the first aspect of the security mailing system 10 can also (a) receive destination address data for the mailing 500 from the customer, (b) place the received destination address data along with the identification code data upon the secured mailing 500, (c) correlate the destination address data placed upon the mailing 500 with the identification code data placed upon the same mailing 500, and (d) retrievably store the correlated identification code data and destination address data in electronic data storage.

A second aspect of the invention effective for enhancing the security of mailings 500 processed by the security mailing system 10 (i) senses and records biometric data from a customer, such as a facial photograph, and (ii) automatically places at least a portion of the, biometric data sensed from the customer onto a mailing received from the customer.

A second embodiment of the second aspect of the invention effective for enhancing the security of mailings 500 processed by the security mailing system 10 (i) senses and records biometric data from a customer, such as a facial photograph, and (ii) automatically places at least a portion of the sensed biometric data upon a mailing 500 contemporaneously received and securely retained within processing chamber 109. Placing such biometric data onto the mailing 500 allows subsequent location and identification of a person involved with posting of a mailing 500, and allows the recipient (not shown) of the mailing 500 to obtain information about the customer prior to accepting and opening the mailing 500.

A third aspect of the invention effective for enhancing the security of mailings 500 processed by the security mailing system 10 (i) senses and records biometric data from a customer contemporaneously with receipt and retention of a mailing 500 within the within processing chamber 109, (ii) accesses a database containing biometric data of persons prone to misconduct involving mailings, (iii) compares the sensed biometric data with the biometric data in the biometric database, (iv) automatically identifies the mailing 500 within the within processing chamber 109 as a suspicious mailing when the sensed biometric data matches biometric data in the biometric database, and (v) automatically provides authorities with notice of receipt of a suspicious mailing when a suspicious mailing is identified. This aspect of the security mailing system 10 discourages persons prone to misconduct involving mailings from using the security mailing system 10, thereby encouraging such persons to utilize a public manned facility for mailing, and allows the proper authorities to quickly and easily identify any mailings 500 which should be given particular attention during shipment and delivery.

Optionally, the third aspect of the security mailing system 10 can also (a) receive destination address data for the mailing 500 from the customer, (b) access a database containing destination address data for target destinations, (c) compare the received destination address data with destination address data in the destination address database, and (d) identify the mailing 500 as a suspicious mailing only when both (1) the sensed biometric data matches biometric data in the biometric database, and (2) the received destination address data matches a target destination address in the destination address database.

Optionally, the third aspect of the security mailing system 10 can further (a) receive destination address data for the mailing 500 from the customer, (b) access a database containing destination address data correlated with telecommunications contact information, (c) compare the received destination address data with destination address data in the destination address database, and (d) when a matching destination address is found in the destination address database, transmit notice of receipt of a suspicious mailing using the telecommunications contact information correlated to the matched destination address.

A fourth aspect of the invention effective for enhancing the security of mailings 500 processed by the security mailing system 10 (i) renders the mailing system 10 normally inoperable for processing a mailing 500, (ii) senses and records biometric data from a customer, (iii) accesses a database containing biometric data of persons prone to misconduct involving mailings, (iv) compares the sensed biometric data with biometric data in the biometric database, and (v) renders the mailing system 10 operable for processing a mailing 500, preferably operable for processing a single mailing 500, only when the sensed biometric data does not match biometric data in the biometric database. This aspect of the security mailing system 10 discourages persons prone to misconduct involving mailings from attempting to use the security mailing system 10, thereby encouraging such persons to utilize a public manned facility for mailing, and actually prevents those persons actually listed on the database of persons prone to misconduct involving mailings from using the security mailing system 10.

Optionally the fourth aspect of the security mailing system 10 can also (a) receive destination address data for the mailing 500 from the customer, (b) access a database containing destination address data for target destinations, (c) compare the received destination address data with destination address data in the destination address database, and (d) temporarily render the security mailing system 10 operational for processing a mailing 500 when either (1) the sensed biometric data does not match biometric data in the biometric database, and (2) the received destination address data does not match a target destination address in the destination address database.

A fifth aspect of the invention effective for enhancing the security of mailings 500 processed by the security mailing system 10 (i) senses mailing type data about a mailing securely retained within the processing chamber 109, (ii) accesses a database containing mailing type data for mailing types posing an increased threat for use in misconduct involving a mailing, (iii) compares the sensed mailing type data with the mailing type data in the mailing type database, (v) automatically identifies a mailing 500 retained within the processing chamber 109 as a suspicious mailing 500 when the sensed mailing type data matches a mailing type in the mailing type database, and (vi) automatically provides authorities with notice of receipt of a suspicious mailing when a suspicious mailing is identified. This aspect of the security mailing system 10 discourages persons from using the security mailing system 10 when a mailing 500 is actually a mailing to be used in misconduct involving a mailing, and allows the proper authorities to quickly and easily identify any mailings 500 which should be given particular attention during shipment and delivery.

Optionally, the fifth aspect of the security mailing system 10 can also (a) receive destination address data for the mailing 500 from the customer, (b) access a database containing destination address data for target destinations, (c) compare the received destination address data with destination address data in the destination address database, and (d) identify the mailing 500 as a suspicious mailing only when both (1) the sensed mailing type data matches mailing type data in the mailing type database, and (2) the received destination address data matches a target destination address in the destination address database.

Optionally, the fifth aspect of the security mailing system 10 can further (a) receive destination address data for the mailing 500 from the customer, (b) access a database containing destination address data correlated with telecommunications contact information, (c) compare the received destination address data with destination address data in the destination address database, and (d) when a matching destination address is found in the destination address database, transmit notice of receipt of a suspicious mailing using the telecommunications contact information correlated to the matched destination address.

The various databases (e.g., biometric database of persons prone to misconduct involving mailings, database of mailing type data for mailing types posing an increased threat for use in misconduct involving a mailing, database of destination address data for target destinations, etc.) are preferably stored at a central location with access provided by any of the normal telecommunications options, such as a telephone line or DSL.

Identification of a mailing 500 as a suspicious mailing can be accomplished by placing identifying indicia directly upon the mailing 500 (e.g., printing a code on the mailing 500 or placing a highly visible sticker on the mailing 500). Alternatively, identification can be accomplished by placing an identification code upon the mailing 500, preserving the identification code in electronic memory, and electronically tagging the identification code as a suspicious mailing.

Notice can be provided to authorities silently via the communications link 220, such as by transmission of an automatically generated e-mail or sounding of a remote alarm, so as not to warn or alarm the customer. Local notice effective for notifying persons in the vicinity of the security mailing system 10, including the customer, can also or alternatively be provided. As depicted in FIG. 1, local notice can be provided by activating a warning light 95 mounted atop the security mailing system 10 and/or generating an alarm through speaker 96 on the security mailing system 10.

1-21. (Cancelled).

22. A secure mailing system, comprising:
(a) means for receiving and securely retaining a mailing;
(b) means for sensing biometric data about a customer;
(c) meaning for accessing a database containing biometric data of persons prone to misconduct involving mailings;
(d) means for comparing sensed biometric data with stored data in a database; and
(e) means for providing an indication of a suspicious mailing as a function of the sensed biometric data and the data in the database;

23. The secure mailing system of claim 1 further comprising (i) means for a customer to input destination address data for a mailing, (ii) means for accessing a database containing destination address data for target destinations, and (iii) means for comparing input destination data with destination address data in the destination address database, further including means for temporarily rendering the security mailing system inoperational as a function of said sensed biometric data as compared to the stored data in said database.

24. The secure mailing system of claim 1 further comprising an electronic camera operable for recording the area surrounding the secure mailing system.

25. The secure mailing system of claim 1 further comprising a means for automatically providing notice to a third party as a function of said sensed biometric data as compared with said stored data in said database.

26. The secure mailing system of claim 1 wherein the means for sensing biometric data includes a digital fingerprinting system and the biometric data includes a digital fingerprint data.

27. The secure mailing system of claim 1 wherein the means for accessing a database includes a communications system for accessing a remote database.

28. The secure mailing system of claim 4 wherein the means for providing notice includes a communications system for automatically transmitting notice to a remote location.
